(19) United States
(12) Patent Application Publication
(10) Pub. No.: US 2024/0422643 A1
(43) Pub. Date: Dec. 19, 2024

(54) EARLY DETECTION OF FAST MASTER CELL GROUP RECOVERY FAILURE

(71) Applicant: Nokia Technologies Oy, Espoo (FI)

(72) Inventors: Irina-Mihaela BALAN, Munich (DE); Ahmad AWADA, Munich (DE); Guillaume DECARREAU, Munich (DE); Sina KHATIBI, Munich (DE); Ugur Baran ELMALI, Munich (DE)

(21) Appl. No.: 18/703,138

(22) PCT Filed: Sep. 13, 2022
(86) PCT No.: PCT/EP2022/075410

§ 371 Date: Apr. 19, 2024

(30) Foreign Application Priority Data
Oct. 20, 2021 (FI) 20216086

(51) Int. Cl. H04W 36/30; H04W 36/00

(52) U.S. Cl. CPC H04W 36/305; H04W 36/0079

(57) ABSTRACT

The present disclosure relates generally to the field of wireless communications, and particularly to a network-based mechanism for early detection of failures during fast Master Cell Group (MCG) recovery. For this purpose, a Secondary Node (SN) may determine that a User Equipment (UE) experiencing an MCG failure is unable to receive a command for handover (HO) from a source MCG to a target MCG. This determination may be based on the occurrence of at least one of the following events: (i) a recovery timer (e.g., T316 timer) has expired at the UE, and (ii) a number of retransmissions performed by the SN to deliver the HO command to the UE reaches a threshold before the recovery timer expires. The SN may then report the fast MCG recovery failure to a Master Node (MN), with the indication that event (i) and/or event (ii) has occurred. This may allow the MN to take appropriate actions (e.g., properly correct the recovery timer), which may in turn decrease the interruption time caused by similar MCG failures and save network resources in the future.

### TECHNICAL FIELD

The present disclosure relates generally to the field of wireless communications, and particularly to a network-based mechanism for early detection of failures during fast Master Cell Group (MCG) recovery.

### BACKGROUND

In Dual Connectivity (DC), a User Equipment (UE) is connected simultaneously to a Master Node (MN) and a Secondary Node (SN). The UE can be configured to operate in a Carrier Aggregation (CA) mode with each of the MN and the SN. The cells of the MN where the UE is operating in the CA mode are referred to as a Master Cell Group (MCG), while those of the SN are referred to as a Secondary Cell Group (SCG).

In the 3^{rd} Generation Partnership Project (3GPP) Release-16, a set of CA- and DC-related features were released. One of such features is ‘Fast MCG recovery from Radio Link Failure (RLF)’. The goal of the fast MCG recovery is to decrease a (connection) interruption time during the MCG failure by using the existing link between the UE and the SN (i.e., SCG connectivity) to recover a MN link as soon as possible. By utilizing the SCG connectivity, the interruption time caused by the MCG failure can be reduced from several seconds down to a typical handover (HO) interruption time of 30-70 ms. For end users, this directly translates into decreased service interruption times.

However, the fast MCG recovery may not always be successful. It is sometimes important to stop the fast MCG recovery as soon as it is determined that the fast MCG recovery is not possible or will likely fail, in order not to further increase the interruption time. One way to achieve this is to use a proper setting for the so-called T316 timer. This timer is used to ensure that the UE will not wait for a HO command from the MN for an indefinite period of time. However, the decision consisting in simply setting the T316 timer to a very small value is not the best one, since it may not allow enough time for a possible recovery from the MCG failure.

Thus, there is a need for a network-based mechanism that would stop the fast MCG recovery when it is not possible or will likely fail, as well as could tune the T316 timer to an optimal value (e.g., long enough, so that the UE has the maximum chances of receiving the HO command from the MN, and, at the same time, short enough, so that the UE does not waste time waiting for the HO command that will never arrive).

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that enables early detection of failures during fast MCG recovery.

The objective above is achieved by the features of the independent claims in the appended claims. Further embodiments and examples are apparent from the dependent claims, the detailed description and the accompanying drawings.

According to a first aspect, a SN in a wireless communication network is provided. The SN comprises at least one processor and at least one memory. The at least one memory comprises a computer program code. The at least one memory and the computer program code are configured to, with the at least one processor, cause the SN to operate at least as follows. At first, the SN is caused to receive, from a UE, a UE message indicating that a RLF occurs at the UE for an MCG of a MN in the wireless communication network. The RLF for the MCG causes the UE to start a recovery timer upon transmitting the UE message from the UE to the SN. Then, the SN is further caused to calculate a start time of the recovery timer at the UE based on a time instant at which the UE message is received. Next, the SN is caused to transmit the UE message to the MN and, in response, receive a MN message from the MN. The MN message comprises a HO command that causes the UE to perform HO from the MN to a target MN. The recovery timer comprises a timer duration indicated in the UE message or the MN message. The SN is further caused to estimate when the recovery timer expires at the UE based on the start time and the timer duration. After that, the SN is further caused to determine that the UE fails to receive the HO command due to at least one of the following events: (i) the recovery timer has expired, and (ii) a number of retransmissions performed by the SN to deliver the HO command to the UE reaches a threshold before the recovery timer expires. Further, the SN is caused to transmit, to the MN, a SN message indicating that the UE fails to receive the HO command due to said at least one of events (i) and (ii). In this example embodiment, the SN may become aware of the recovery-timer (e.g., T316) setting (which is normally only visible to the UE and the MN) and carry out its own estimation of the elapsed time of the recovery timer since the MCG failure. By so doing, the SN may early detect and report failures during the MCG recovery to the MN (or any central entity in the wireless communication network, such, e.g., as a near Real-Time Radio Access Network (RAN) Intelligent Controller (nRT-RIC), etc.), so that the MN could take appropriate actions (e.g., properly correct the recovery timer). This in turn will allow one to decrease the interruption time caused by the MCG failure and save network resources in the future.

In one example embodiment of the first aspect, the SN message further indicates at least one of the following: an elapsed value of the recovery timer when event (ii) occurs, and the number of the retransmissions performed by the SN to deliver the HO command to the UE when event (i) occurs. By indicating such additional information in the SN message, the SN may allow the MN to properly make timer configuration optimization. Using the optimized recovery timer (e.g., the optimized T316 timer) may in turn improve both network and UE performances in the future.

According to a second aspect, a MN in a wireless communication network is provided. The MN comprises at least one processor and at least one memory. The at least one memory comprises a computer program code. The at least one memory and the computer program code are configured to, with the at least one processor, cause the MN to operate at least as follows. At first, the MN is caused to receive, from a SN in the wireless communication network, a UE message indicating that a RLF occurs at the UE for an MCG of the MN. The RLF for the MCG causes the UE to start a recovery timer upon transmitting the UE message from the UE to the SN. Then, the MN is caused to transmit a HO request to a target MN and, in response, receive a HO request acknowledgement from the target MN. Further, the MN is caused to transmit a MN message to the SN. The MN message comprises a HO command for the UE that causes the UE to perform HO from the MN to the target MN. The recovery timer comprises a timer duration indicated in the MN message. The MN is further caused to receive, from the SN, a SN message indicating that the UE fails to receive the HO command due to at least one of the following events: (i) the recovery timer has expired, and (ii) a number of retransmissions performed by the SN to deliver the HO command to the UE reaches a threshold before the recovery timer expires. By using such a SN message, the MN may be promptly informed about failures during the MCG recovery and, therefore, could take appropriate actions (e.g., properly correct the recovery timer). This in turn will allow one to decrease the interruption time caused by the MCG failure and save network resources in the future.

In one example embodiment of the second aspect, the SN message further indicates at least one of the following: an elapsed value of the recovery timer when event (ii) occurs, and the number of the retransmissions performed by the SN to deliver the HO command to the UE when event (i) occurs. With such additional information in the SN message, the MN may properly make timer configuration optimization. Using the optimized recovery timer (e.g., the optimized T316 timer) may in turn improve both network and UE performances in the future.

In one example embodiment of the second aspect, the at least one memory and the computer program code are further configured to, with the at least one processor, cause the MN to increase the timer duration of the recovery timer if the number of the retransmissions performed by the SN to deliver the HO command to the UE is less than the threshold when event (i) occurs. In this case, the recovery timer is found to be too short, for which reason the MN may increase the value of the recovery timer in the future. This may increase the chances for the UE to receive the HO command.

In one example embodiment of the second aspect, the at least one memory and the computer program code are further configured to, with the at least one processor, cause the MN to decrease the timer duration of the recovery timer if the number of the retransmissions performed by the SN to deliver the HO command to the UE reaches the threshold before event (i) occurs. In this case, the recovery timer is found to be too long, for which reason the MN may decrease the value of the recovery timer in the future. Having a too long recovery timer is not beneficial for the UE, as it will increase the interruption time even more.

According to a third aspect, a UE in a wireless communication network is provided. The UE comprises at least one processor and at least one memory. The at least one memory comprises a computer program code. The at least one memory and the computer program code are configured to, with the at least one processor, cause the UE to operate at least as follows. At first, the UE is caused to detect a RLF for an MCG of a MN in the wireless communication network. Then, the UE is caused to transmit a UE message to a SN in the wireless communication network. The UE message indicates that the RLF occurs at the UE for the MCG of the MN. Next, after the UE message is transmitted, the UE is caused to start a recovery timer. The recovery timer comprises a timer duration indicated in the UE message. By so doing, the UE may inform the SN about the setting of its recovery timer (e.g., T316) (which is normally only visible to the UE and the MN), so that the SN could carry out its own estimation of the elapsed time of the recovery timer since the MCG failure. This may in turn allow the SN to early detect failures during the MCG recovery and report such MCG recovery failures to the MN.

According to a fourth aspect, a method for operating a SN in a wireless communication network is provided. The method starts with the step of receiving, from a UE, a UE message indicating that a RLF occurs at the UE for an MCG of a MN in the wireless communication network. The RLF for the MCG causes the UE to start a recovery timer upon transmitting the UE message from the UE to the SN. Then, the method goes on to the step of calculating a start time of the recovery timer at the UE based on a time instant at which the UE message is received. Next, the method proceeds to the steps of transmitting the UE message to the MN and receiving, from the MN, a MN message comprising a HO command for the UE. The HO command causes the UE to perform HO from the MN to a target MN. The recovery timer comprises a timer duration indicated in the UE message or the MN message. The method further proceeds to the step of estimating when the recovery timer expires at the UE based on the start time and the timer duration. After that, the method goes on to the step of determining that the UE fails to receive the HO command due to at least one of the following events: (i) the recovery timer has expired, and (ii) a number of retransmissions performed by the SN to deliver the HO command to the UE reaches a threshold before the recovery timer expires. The method ends up with the step of transmitting, to the MN, a SN message indicating that the UE fails to receive the HO command due to said at least one of events (i) and (ii). Thus, the SN may become aware of the recovery-timer (e.g., T316) setting (which is normally only visible to the UE and the MN) and carry out its own estimation of the elapsed time of the recovery timer since the MCG failure. By so doing, the SN may early detect and report failures during the MCG recovery to the MN (or any central entity in the wireless communication network, such, e.g., as an nRT-RIC, etc.), so that the MN could take appropriate actions (e.g., properly correct the recovery timer). This in turn will allow one to decrease the interruption time caused by the MCG failure and save network resources in the future.

In one example embodiment of the fourth aspect, the SN message further indicates at least one of the following: an elapsed value of the recovery timer when event (ii) occurs; and the number of the retransmissions performed by the SN to deliver the HO command to the UE when event (i) occurs. By indicating such additional information in the SN message, the SN may allow the MN to properly make timer configuration optimization. Using the optimized recovery timer (e.g., the optimized T316 timer) may in turn improve both network and UE performances in the future.

According to a fifth aspect, a method for operating a MN in a wireless communication network is provided. The method starts with the step of receiving, from a SN in the wireless communication network, a UE message indicating that a RLF occurs at the UE for an MCG of the MN. The RLF for the MCG causes the UE to start a recovery timer upon transmitting the UE message from the UE to the SN. Then, the method proceeds to the steps of transmitting a HO request to a target MN, and receiving, from the target MN, a HO request acknowledgement. Next, the method goes on to the step of transmitting a MN message to the SN. The MN message comprises a HO command for the UE that causes the UE to perform HO from the MN to the target MN. The recovery timer comprises a timer duration indicated in the MN message. The method further proceeds to the step of receiving, from the SN, a SN message indicating that the UE fails to receive the HO command due to at least one of the following events: (i) the recovery timer has expired, and (ii) a number of retransmissions performed by the SN to deliver the HO command to the UE reaches a threshold before the recovery timer expires. By using such a SN message, the MN may be informed about failures during the MCG recovery and, therefore, could take appropriate actions (e.g., properly correct the recovery timer). This in turn will allow one to decrease the interruption time caused by the MCG failure and save network resources in the future.

In one example embodiment of the fifth aspect, the SN message further indicates at least one of the following: an elapsed value of the recovery timer when event (ii) occurs; and the number of the retransmissions performed by the SN to deliver the HO command to the UE when event (i) occurs. By indicating such additional information in the SN message, the SN may allow the MN to properly make timer configuration optimization. Using the optimized recovery timer (e.g., the optimized T316 timer) may in turn improve both network and UE performances in the future.

In one example embodiment of the fifth aspect, the method further comprises the step of increasing the timer duration of the recovery timer if the number of the retransmissions performed by the SN to deliver the HO command to the UE is less than the threshold when event (i) occurs. In this case, the recovery timer is found to be too short, for which reason the MN may increase the value of the recovery timer in the future. This may increase the chances for the UE to receive the HO command.

In one example embodiment of the fifth aspect, the method further comprises the step of decreasing the timer duration of the recovery timer if the number of the retransmissions performed by the SN to deliver the HO command to the UE reaches the threshold before event (i) occurs. In this case, the recovery timer is found to be too long, for which reason the MN may decrease the value of the recovery timer in the future. Having a too long recovery timer is not beneficial for the UE, as it will increase the interruption time even more.

According to a sixth aspect, a method for operating a UE in a wireless communication network is provided. The method starts with the step of detecting a RLF for an MCG of a MN in the wireless communication network. Then, the method proceeds to the step of transmitting a UE message to a SN in the wireless communication network. The UE message indicates that the RLF occurs at the UE for the MCG of the MN. Next, after the UE message is transmitted, the method goes on to the step of starting a recovery timer. The recovery timer comprises a timer duration indicated in the UE message. By so doing, the UE may inform the SN about the setting of its recovery timer (e.g., T316) (which is normally only visible to the UE and the MN), so that the SN could carry out its own estimation of the elapsed time of the recovery timer since the MCG failure. This may in turn allow the SN to early detect failures during the MCG recovery and report such MCG recovery failures to the MN.

According to a seventh aspect, a computer program product is provided. The computer program product comprises a computer-readable storage medium that stores a computer code. Being executed by at least one processor, the computer code causes the at least one processor to perform the method according to the fourth aspect. By using such a computer program product, it is possible to simplify the implementation of the method according to the fourth aspect in any network node, like the SN according to the first aspect.

According to an eighth aspect, a computer program product is provided. The computer program product comprises a computer-readable storage medium that stores a computer code. Being executed by at least one processor, the computer code causes the at least one processor to perform the method according to the fifth aspect. By using such a computer program product, it is possible to simplify the implementation of the method according to the fifth aspect in any network node, like the MN according to the second aspect.

According to a ninth aspect, a computer program product is provided. The computer program product comprises a computer-readable storage medium that stores a computer code. Being executed by at least one processor, the computer code causes the at least one processor to perform the method according to the sixth aspect. By using such a computer program product, it is possible to simplify the implementation of the method according to the sixth aspect in any UE, like the UE according to the third aspect.

According to a tenth aspect, a SN in a wireless communication network is provided. The SN comprises a means for receiving, from a UE, a UE message indicating that a RLF occurs at the UE for an MCG of a MN in the wireless communication network. The RLF for the MCG causes the UE to start a recovery timer upon transmitting the UE message from the UE to the SN. The SN further comprises a means for calculating a start time of the recovery timer at the UE based on a time instant at which the UE message is received. The SN further comprises a means for transmitting the UE message to the MN. The SN further comprises a means for receiving a MN message from the MN. The MN message comprises a HO command for the UE that causes the UE to perform HO from the MN to a target MN. The recovery timer comprises a timer duration indicated in the UE message or MN message. The SN further comprises a means for estimating when the recovery timer expires at the UE based on the start time and the timer duration. The SN further comprises a means for determining that the UE fails to receive the HO command due to at least one of the following events: (i) the recovery timer has expired, and (ii) a number of retransmissions performed by the SN to deliver the HO command to the UE reaches a threshold before the recovery timer expires. The SN further comprises a means for transmitting, to the MN, a SN message indicating that the UE fails to receive the HO command due to said at least one of events (i) and/or (ii). In this configuration, the SN may become aware of the recovery-timer (e.g., T316) setting (which is normally only visible to the UE and the MN) and carry out its own estimation of the elapsed time of the recovery timer since the MCG failure. By so doing, the SN may early detect and report failures during the MCG recovery to the MN (or any central entity in the wireless communication network, such, e.g., as an nRT-RIC, etc.), so that the MN could quickly take appropriate actions (e.g., properly correct the recovery timer). This in turn will allow one to decrease the interruption time caused by the MCG failure and save network resources in the future.

According to an eleventh aspect, a MN in a wireless communication network is provided. The MN comprises a means for receiving, from a SN in the wireless communication network, a UE message indicating that a RLF occurs at a UE for an MCG of the MN. The RLF for the MCG causes the UE to start a recovery timer upon transmitting the UE message from the UE to the SN. The MN further comprises a means for transmitting a HO request to a target MN. The MN further comprises a means for receiving a HO request acknowledgement from the target MN. The MN further comprises a means for transmitting a MN message to the SN. The MN message comprises a HO command for the UE that causes the UE to perform HO from the MN to the target MN. The recovery timer comprises a timer duration indicated in the MN message. The MN further comprises a means for receiving, from the SN, a SN message indicating that the UE fails to receive the HO command due to at least one of the following events: (i) the recovery timer has expired, and (ii) a number of retransmissions performed by the SN to deliver the HO command to the UE reaches a threshold before the recovery timer expires. By using such a SN message, the MN may be promptly informed about failures during the MCG recovery and, therefore, could take appropriate actions (e.g., properly correct the recovery timer). This in turn will allow one to decrease the interruption time caused by the MCG failure and save network resources in the future.

According to a twelfth aspect, a UE in a wireless communication network is provided. The UE comprises a means for detecting a RLF for an MCG of a MN in the wireless communication network. The UE further comprises a means for transmitting a UE message to a SN in the wireless communication network. The UE message indicates that the RLF occurs at the UE for the MCG of the MN. The UE further comprises a means for starting a recovery timer after the UE message is transmitted. The recovery timer comprises a timer duration indicated in the UE message. By so doing, the UE may inform the SN about the setting of its recovery timer (e.g., T316) (which is normally only visible to the UE and the MN), so that the SN could carry out its own estimation of the elapsed time of the recovery timer since the MCG failure. This may in turn allow the SN to early detect failures during the MCG recovery and report such MCG recovery failures to the MN.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows an interaction diagram that explains the interaction between a User Equipment (UE), a source Master Node (MN), a Secondary Node (SN), and a target MN during a Master Cell Group (MCG) recovery procedure in accordance with the prior art;

FIG. 2 shows a block diagram of a SN in accordance with one example embodiment;

FIG. 3 shows a flowchart of a method for operating the SN shown in FIG. 2 in accordance with one example embodiment;

FIG. 4 shows a block diagram of a MN in accordance with one example embodiment;

FIG. 5 shows a flowchart of a method for operating the MN shown in FIG. 4 in accordance with one example embodiment;

FIG. 6 shows a block diagram of a UE in accordance with one example embodiment;

FIG. 7 shows a flowchart of a method for operating the UE shown in FIG. 6 in accordance with one example embodiment; and

FIG. 8 shows an interaction diagram that explains the interaction between a UE, a source MN, a SN, and a target MN during the MCG recovery procedure in accordance with one exemplary embodiment.

### DETAILED DESCRIPTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatuses and methods disclosed herein can be implemented in practice by using any numbers of the embodiments provided herein. Furthermore, it should be understood that any embodiment of the present disclosure can be implemented using one or more of the elements presented in the appended claims.

Unless otherwise stated, any embodiment recited herein as “example embodiment” should not be construed as preferable or having an advantage over other embodiments.

According to the example embodiments disclosed herein, a User Equipment (UE) may refer to an electronic computing device that is configured to perform wireless communications. The UE may be implemented as a mobile station, a mobile terminal, a mobile subscriber unit, a mobile phone, a cellular phone, a smart phone, a cordless phone, a personal digital assistant (PDA), a wireless communication device, a laptop computer, a tablet computer, a gaming device, a netbook, a smartbook, an ultrabook, a medical mobile device or equipment, a biometric sensor, a wearable device (e.g., a smart watch, smart glasses, a smart wrist band, etc.), an entertainment device (e.g., an audio player, a video player, etc.), a vehicular component or sensor (e.g., a driver-assistance system), a smart meter/sensor, an unmanned vehicle (e.g., an industrial robot, a quadcopter, etc.) and its component (e.g., a self-driving car computer), industrial manufacturing equipment, a global positioning system (GPS) device, an Internet-of-Things (IoT) device, an Industrial IoT (IIoT) device, a machine-type communication (MTC) device, a group of Massive IoT (MIoT) or Massive MTC (mMTC) devices/sensors, or any other suitable mobile device configured to support wireless communications. In some embodiments, the UE may refer to at least two collocated and inter-connected UEs thus defined.

As used in the example embodiments disclosed herein, each of a Master Node (MN) and a Secondary Node (SN) may refer to a network node that is a fixed point of communication for a UE in a particular wireless communication network. The network node may be referred to as a base transceiver station (BTS) in terms of the 2G communication technology, a NodeB in terms of the 3G communication technology, an evolved NodeB (eNodeB) in terms of the 4G communication technology, and a gNB in terms of the 5G New Radio (NR) communication technology. The network node may serve different cells, such as a macrocell, a microcell, a picocell, a femtocell, and/or other types of cells. The macrocell may cover a relatively large geographic area (for example, at least several kilometers in radius). The microcell may cover a geographic area less than two kilometers in radius, for example. The picocell may cover a relatively small geographic area, such, for example, as offices, shopping malls, train stations, stock exchanges, etc. The femtocell may cover an even smaller geographic area (for example, a home). Correspondingly, the network node serving the macrocell may be referred to as a macro node, the network node serving the microcell may be referred to as a micro node, and so on.

According to the example embodiments disclosed herein, a wireless communication network, in which a UE, a SN, and a MN communicate with each other, may refer to a cellular or mobile network, a Wireless Local Area Network (WLAN), a Wireless Personal Area Networks (WPAN), a Wireless Wide Area Network (WWAN), a satellite communication (SATCOM) system, or any other type of wireless communication networks. Each of these types of wireless communication networks supports wireless communications according to one or more communication protocol standards. For example, the cellular network may operate according to the Global System for Mobile Communications (GSM) standard, the Code-Division Multiple Access (CDMA) standard, the Wide-Band Code-Division Multiple Access (WCDM) standard, the Time-Division Multiple Access (TDMA) standard, or any other communication protocol standard, the WLAN may operate according to one or more versions of the IEEE 802.11 standards, the WPAN may operate according to the Infrared Data Association (IrDA), Wireless USB, Bluetooth, or ZigBee standard, and the WWAN may operate according to the Worldwide Interoperability for Microwave Access (WiMAX) standard. In some embodiments, the wireless communication network may be implemented as a Self-organizing Network (SON).

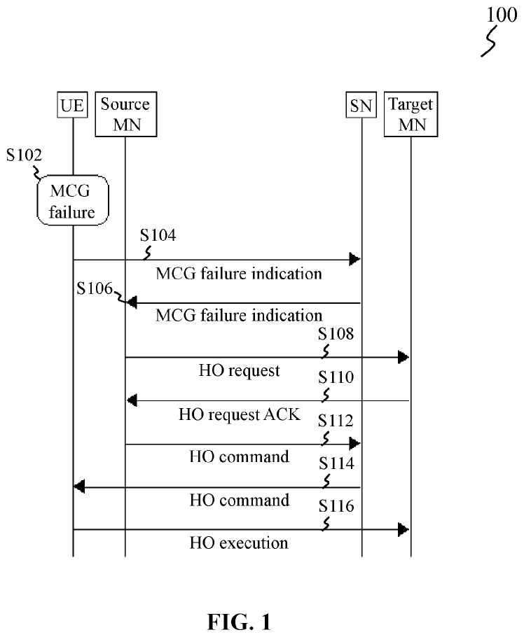

FIG. 1 shows an interaction diagram 100 that explains the interaction between a UE, a source MN, a SN, and a target MN during an MCG recovery procedure in accordance with the prior art. More specifically, it is implied that the MCG recovery procedure is initiated due to an MCG failure (i.e., when there is a RLF for an MCG).

The interaction diagram 100 starts with a step S102, in which the UE starts experiencing the MCG failure. It is also implied that the UE is configured with the T316 timer and a SCG is not suspended during the MCG failure. In this case, the UE does not trigger a Radio Resource Control (RRC) re-establishment procedure upon detecting the MCG failure. Instead, the UE suspends MCG transmissions of all bearers and prepares an MCG failure indication or information message that contains the reason for the MCG failure plus any available measurements at the time of the MCG failure, in order to help the network take an appropriate action.

Next, the interaction diagram 100 proceeds to a step S104, in which the UE transmits the MCG failure indication to the network by using the SCG radio resources either in split Signaling Radio Bearer (SRB) 1 or SRB 3. The UE also starts the T316 timer at this point. If both split SRB 1 and SRB 3 are configured, the UE sends the message via split SRB 1. Instead, if the message is sent via SRB 3, the SN will forward the MCG failure indication to the source MN in a next step S106 via an internode interface between the source MN and SN (e.g., by using an RRC Transfer procedure).

Upon receiving the MCG failure indication from the SN, the source MN determines the best action to address the MCG failure based on, for example, measurement information received from the UE (such information may be included in the MCG failure indication). The action may typically be a UE reconfiguration to change the MCG of the source MN to the MCG of the target MN to restore the MCG connectivity. For this purpose, the source MN transmits a HO request to the target MN in a step S108 and, in response, receives a HO request acknowledgement in a step S110. Alternatively, if no suitable target MN is determined, the source MN may send an RRC release message to the UE, which causes the UE to release the current connection with the source MN via its MCG resources.

In case if split SRB 1 is used, the MN sends a response message (with a HO command) is directly sent to the UE by using an SCG leg of the split SRB. In case if SRB 3 is used, the MN sends the response message to the SN. The latter is implied as a next step S112 in the interaction diagram 100

The interaction diagram 100 further proceeds to a step S114, in which the SN encapsulates the HO command in an SN RRC message and sends the SN RRC message to the UE.

In a next step S116, the UE executes the HO command (e.g., by using a Random Access Channel (RACH) procedure) as soon as possible following the reception of the SN RRC message. The HO command may be executed by the UE before confirming successful reception (e.g., by using an Automatic Repeat Request (ARQ) or hybrid ARQ (HARQ)) of the SN RRC message.

As for the T316 timer supervising the whole MCG recovery procedure, it is described in 3GPP TS 38.331 and started immediately upon transmitting the MCG failure indication to the SN in the step S104. The T316 timer ensures that the UE does not need to wait too long for the recovery realized by a new network-initiated HO. This means that UE waits for the RRC release message or the HO command before the T316 timer expires. Upon its expiry, the UE should perform the conventional re-establishment procedure via a Cell Selection procedure defined in 3GPP TS 38.331.

The above-described fast MCG recovery procedure has several advantages: system information does not need to be read from the target MN, a contention-free random access can be used, and the bearers and the SN do not need to be set up from scratch. In other words, this fast MCG recovery procedure allows the signaling overhead and interruption time to be significantly reduced compared to the conventional re-establishment procedure.

However, the fast MCG recovery procedure may not always be successful. It is important to stop the fast MCG recovery procedure as soon as it is determined that the MCG recovery is not possible or the MCG recovery will fail, in order not to further increase the interruption time.

An as example, let us consider the following scenario. A UE is assumed to experience an MCG failure. Then, as follows from the interaction diagram 100, the UE sends an MCG failure indication message to an SN and starts the T316 timer. The SN forwards the received MCG failure indication message to an MN, and the MN sends back a HO command to the UE via an RRC message using an SN link. However, the SN may be unable to deliver the HO command to the UE because the link quality between the SN and the UE is already bad and the RRC message with the HO command cannot be delivered despite the T316 timer is still running on the UE side. Alternatively, the SN may not be able to deliver the HO command to the UE as the T316 timer has already expired and the UE has initiated the conventional re-establishment procedure. In the first case (i.e., when the SN fails to deliver the HO command to the UE due to the bad link quality), the interruption time of the UE is unnecessarily increased. In the second case (i.e., when the SN fails to deliver the HO command to the UE due to the expiry of the T316 timer), the UE misses the chance to execute HO command, which both increases its interruption time and wastes network resources. Moreover, in both such cases of the failed fast MCG recovery, the MN does not have enough information to take corrective actions for the T316 timer.

The example embodiments disclosed herein provide a technical solution that allows mitigating or even eliminating the above-sounded drawbacks peculiar to the prior art. In particular, the technical solution disclosed herein enables early detection of a fast MCG recovery failure. For this purpose, a SN may determine that a UE experiencing an MCG failure is unable to receive a command for HO from a source MCG to a target MCG. This determination may be based on the occurrence of at least one of the following events: (i) a recovery timer (e.g., T316 timer) has expired at the UE, and (ii) a number of retransmissions performed by the SN to deliver the HO command to the UE reaches a threshold before the recovery timer expires. The SN may then report the fast MCG recovery failure to the MN, with the indication of said at least one of events (i) and (ii). This may allow the MN to take appropriate actions (e.g., properly correct the recovery timer), which may in turn decrease the interruption time caused by MCG failures and save network resources in the future.

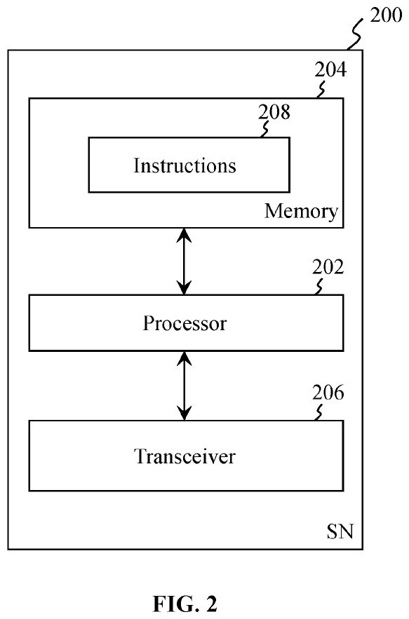

FIG. 2 shows a block diagram of a SN 200 in accordance with one example embodiment. The SN 200 is intended to operate in any of the above-described wireless communication networks. As shown in FIG. 2, the SN 200 comprises a processor 202, a memory 204, and a transceiver 206. The memory 204 stores processor-executable instructions 208 which, when executed by the processor 202, cause the processor 202 to implement the aspects of the present disclosure, as will be described below in more detail. It should be noted that the number, arrangement, and interconnection of the constructive elements constituting the SN 200, which are shown in FIG. 2, are not intended to be any limitation of the present disclosure, but merely used to provide a general idea of how the constructive elements may be implemented within the SN 200. For example, the processor 202 may be replaced with several processors, as well as the memory 204 may be replaced with several removable and/or fixed storage devices, depending on particular applications. Furthermore, in some embodiments, the transceiver 206 may be implemented as two individual devices, with one for a receiving operation and another for a transmitting operation. Irrespective of its implementation, the transceiver 206 is intended to be capable of performing different operations required to perform the data reception and transmission, such, for example, as signal modulation/demodulation, encoding/decoding, etc. In other embodiments, the transceiver 206 may be part of the processor 202 itself.

The processor 202 may be implemented as a CPU, general-purpose processor, single-purpose processor, microcontroller, microprocessor, application specific integrated circuit (ASIC), field programmable gate array (FPGA), digital signal processor (DSP), complex programmable logic device, etc. It should be also noted that the processor 202 may be implemented as any combination of one or more of the aforesaid. As an example, the processor 202 may be a combination of two or more microprocessors.

The memory 204 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 208 stored in the memory 204 may be configured as a computer-executable code which causes the processor 202 to perform the aspects of the present disclosure. The computer-executable code for carrying out operations or steps for the aspects of the present disclosure may be written in any combination of one or more programming languages, such as Java, C++, or the like. In some examples, the computer-executable code may be in the form of a high-level language or in a pre-compiled form and be generated by an interpreter (also pre-stored in the memory 204) on the fly.

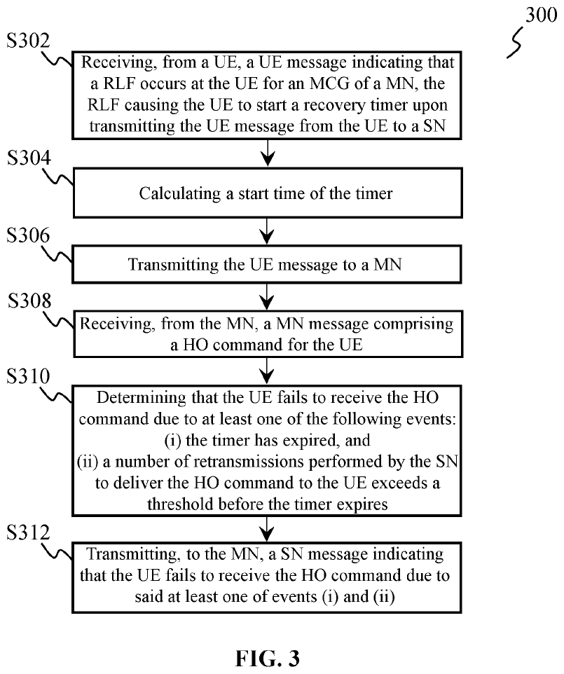

FIG. 3 shows a flowchart of a method 300 for operating the SN 200 in accordance with one example embodiment. The method 300 starts with a step S302, in which the processor 202 receives a UE message from a UE. The UE message indicates that a RLF occurs at the UE for an MCG of a MN in the wireless communication network. The RLF for the MCG causes the UE to start a recovery timer (e.g., the T316 timer) upon transmitting the UE message from the UE to the SN 200. The UE message may further indicate a timer duration of the recovery timer. The recovery timer (e.g., its timer duration and other setting parameters) may be configured by the MN itself, and the MN may deliver the timer setting parameters to the UE earlier than the MCG failure. Then, the method 300 proceeds to a step S304, in which the processor 202 calculates a start time of the recovery timer based on a time instant at which the UE message is received. Next, the method 300 goes on to a step S306, in which the processor 202 transmits the UE message to the MN, and a step S308, in which the processor 202 receives a MN message from the MN. The MN message indicates a HO command for the UE. The HO command causes the UE to perform HO from the (source) MN to a target MN. Alternatively, the MN message may indicate the timer duration, instead of the UE message. In other words, it may be the MN which inform the SN 200 of the timer duration. By using the start time and the timer duration, the SN 200 is able to estimate when the recovery timer expires at the UE. Further, the method 300 goes on to a step S310, in which the processor 202 determines that the UE fails to receive the HO command due to at least one of the following events: (i) the recovery timer has expired, and (ii) a number of retransmissions performed by the SN to deliver the HO command to the UE reaches a threshold before the recovery timer expires. The threshold may be a maximum number of retransmissions which the processor 202 is allowed to perform in an attempt to deliver the HO command to the UE, or any other user-/operator-defined number of retransmissions. After that, the method 300 proceeds to a step S312, in which the processor 202 transmits a SN message to the MN. The SN message indicates that the UE fails to receive the HO command due to said at least one of events (i) and/or (ii). Each of the UE message, HO command, and the SN message may be implemented as a corresponding RRC message, for example.

In one example embodiment, in the step S312, the processor 202 may transmit the SN message to any central entity in the wireless communication network (e.g., as a nRT-RIC, etc.), in addition to or instead of the MN. Such a central entity may collect such SN messages from the SN 200 and decide to make proper adjustments in respect of the recovery timer, if required.

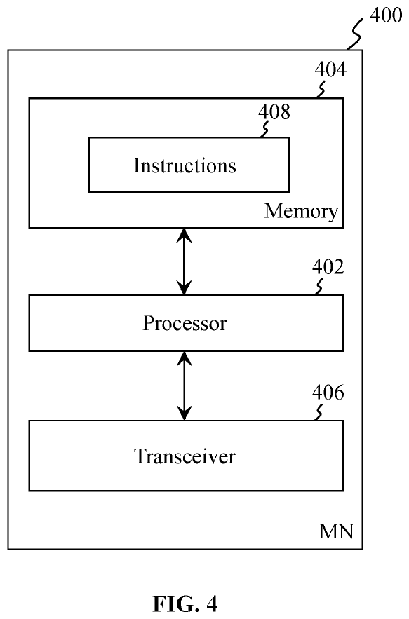

FIG. 4 shows a block diagram of a MN 400 in accordance with one example embodiment. The MN 400 is intended to communicate with the SN 200 in any of the above-described wireless communication networks. As shown in FIG. 4, the MN 400 comprises a processor 402, a memory 404, and a transceiver 406. The memory 404 stores processor-executable instructions 408 which, when executed by the processor 402, cause the processor 402 to implement the aspects of the present disclosure, as will be described below in more detail. It should be again noted that the number, arrangement, and interconnection of the constructive elements constituting the MN 400, which are shown in FIG. 4, are not intended to be any limitation of the present disclosure, but merely used to provide a general idea of how the constructive elements may be implemented within the MN 400. In general, the processor 402, the memory 404, the transceiver 406, and the processor-executable instructions 408 may be implemented in the same or similar manner as the processor 202, the memory 204, the transceiver 206, and the processor-executable instructions 208, respectively.

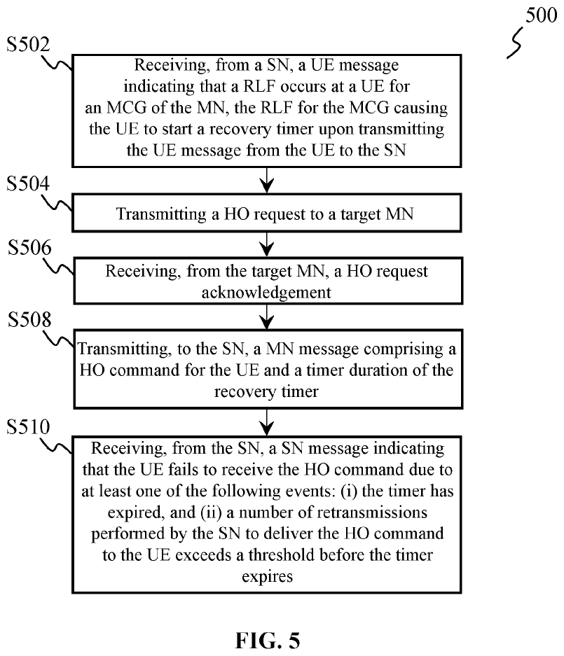

FIG. 5 shows a flowchart of a method 500 for operating the MN 400 in accordance with one example embodiment. The method 500 starts with a step S502, in which the processor 402 receives the UE message from the processor 202 of the SN 200. Then, the method 500 proceeds to a step S504, in which the processor 402 transmits a HO request to a target MN, and a step S506, in which the processor 402 receives a HO request acknowledgement from the target MN. Next, the method 500 goes on to a step S508, in which the processor 402 transmits the MN message to the processor 202 of the SN 200. As noted earlier, the MN message comprises the HO command (e.g., encapsulated in an RRC message) for the UE. The HO command indicates the target MN to which the UE is to perform HO from the MN. The MN message may further comprise the timer duration of the recovery timer started by the UE. After that, the method 500 proceeds to a step S510, in which the processor 402 receives the SN message from the processor 202 of the SN 200. As also noted above, the SN message indicates that the UE fails to receive the HO command due to the occurrence of events (i) and/or (ii).

In some example embodiments, if the SN message further indicates the elapsed value of the recovery timer when event (ii) occurs and/or the number of the retransmissions that the SN 200 has already performed to deliver the HO command to the UE when event (i) occurs, the method 500 may comprise additional steps, in which the processor 402 may decide whether to increase or decrease the timer duration of the recovery timer for its further operation. For example, the processor 402 may adjust the T316 timer (used as the recovery timer at the UE) based on the relationship between the elapsed value of the T316 timer at the SN 200 and the number of the retransmissions performed by the SN 200. Let us consider two possible situations:
(1) If the SN 200 has failed to send the HO command to the UE or only managed to perform a smaller amount of retransmissions (compared to the threshold number of retransmissions) towards the UE before the T316 timer expires, it means that the T316 might have been configured as a too short timer. In this case, the MN 400 may increase the timer duration of the T316 timer in the future. This in turn may increase the chances for the UE to receive the HO command from the SN 200.
(2) If the SN 200 has reached the threshold number of the retransmissions before the T316 timer expires, it means that the UE has no opportunity of receiving the HO command anymore. The UE would then just wait for the T316 timer to expire, so that the UE could initiate the conventional re-establishment procedure. In this case, the T316 timer might have been configured as a too long timer, for which reason the MN 400 may decrease the timer duration of the T316 timer in the future.

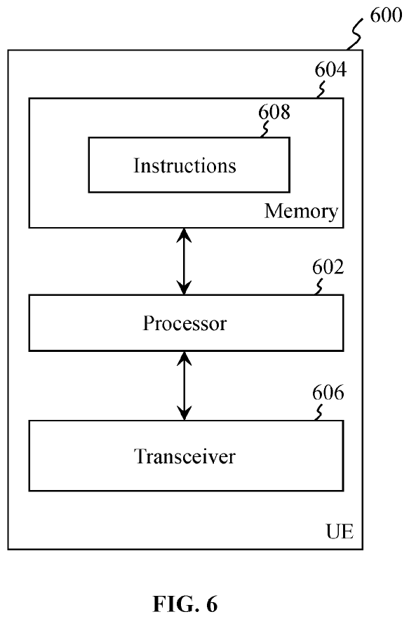

FIG. 6 shows a block diagram of a UE 600 in accordance with one example embodiment. The UE 600 is intended to communicate with the SN 200 and the MN 400 in any of the above-described wireless communication networks. As shown in FIG. 6, the UE 600 comprises a processor 602, a memory 604, and a transceiver 606. The memory 604 stores processor-executable instructions 608 which, when executed by the processor 602, cause the processor 602 to implement the aspects of the present disclosure, as will be described below in more detail. It should be again noted that the number, arrangement, and interconnection of the constructive elements constituting the UE 600, which are shown in FIG. 6, are not intended to be any limitation of the present disclosure, but merely used to provide a general idea of how the constructive elements may be implemented within the UE 600. In general, the processor 602, the memory 604, the transceiver 606, and the processor-executable instructions 608 may be implemented in the same or similar manner as the processor 202, the memory 204, the transceiver 206, and the processor-executable instructions 208, respectively.

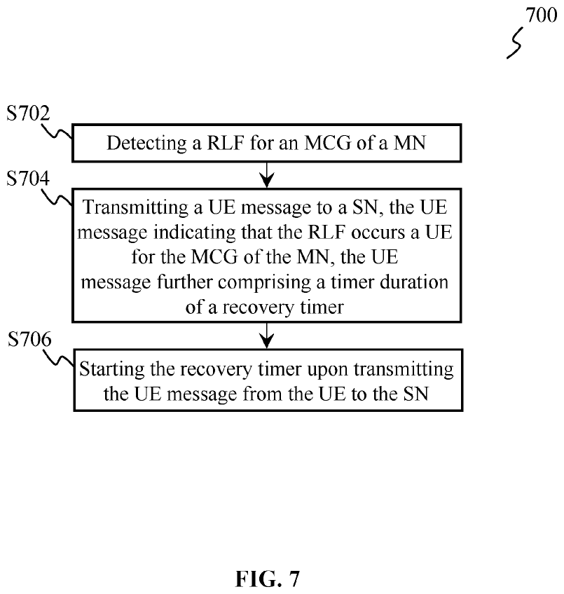

FIG. 7 shows a flowchart of a method 700 for operating the UE 600 in accordance with one example embodiment. The method 700 starts with a step S702, in which the processor 602 detects the RLF for the MCG of the MN 400 in the wireless communication network. Then, the method 700 proceeds to a step S704, in which the processor 602 transmits a UE message to the SN 200 in the wireless communication network. The UE message indicates that the RLF occurs at the UE 600 for the MCG of the MN. In this example embodiment, it is also assumed that the UE message further comprises the timer duration of the recovery timer. Next, after the UE message is transmitted from the UE 600 to the SN 200, the method 700 goes on to a step S706, in which the processor 602 starts the recovery timer.

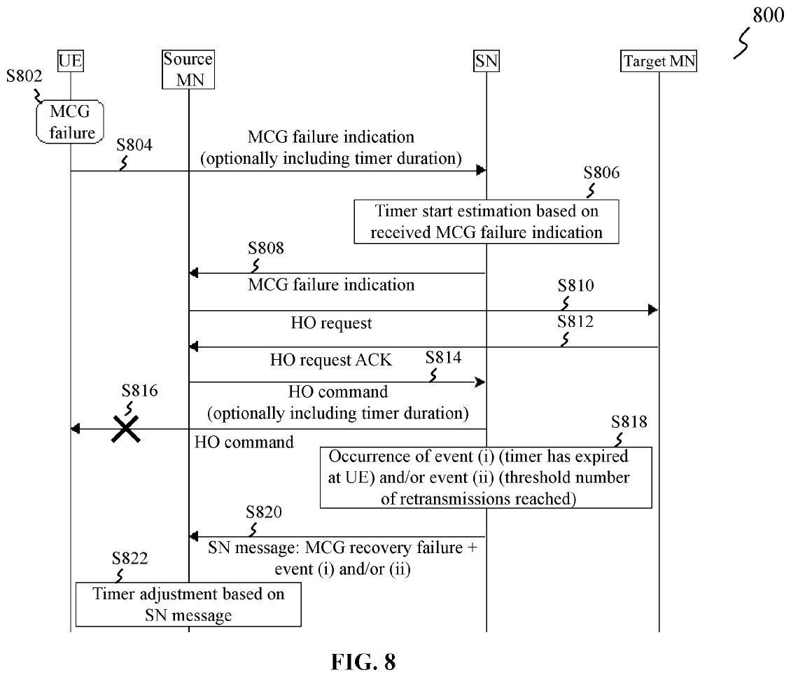

FIG. 8 shows an interaction diagram 800 that explains the interaction between a UE, a source MN, a SN, and a target MN during the MCG recovery procedure in accordance with one exemplary embodiment. The source MN may be implemented as the MN 400, the SN may be implemented as the SN 200, and the UE may be implemented as the UE 600.

The interaction diagram 800 starts with a step S802, in which the UE starts experiencing an MCG failure. It is implied that the UE is configured with a recovery timer (e.g., the T316 timer) and the SCG of the SN is not suspended during the MCG RLF.

In a next step S804, the UE transmits an MCG failure indication to the SN. The indication may optionally indicate the timer setting parameters (e.g., the timer duration) of the recovery timer.

Then, the interaction diagram 800 goes to a step S806, in which the SN estimates the start time of the recovery timer at the UE based on a time instant at which the MCG failure indication is received. By combining the estimated start time with the timer characteristics (e.g., the timer duration), the SN may calculate when the recovery timer expires.

Next, the interaction diagram 800 proceeds to a step S808, in which the SN forwards the MCG failure indication to the source MN, so that the source MN could take further actions.

More specifically, the source MN sends a HO request to the target MN in a step S610 and receives a HO request acknowledgement from the target MN in a step S612. In response to the HO request acknowledgement, the source MN generates a MN message indicating a HO command for the UE. The source MN sends the MN message to the SN in a step S814. Optionally, the MN message may also indicate the timer setting parameters.

Once the HO command is received, the SN starts trying to deliver it to the UE in a step S816 but fails to do this. The SN determines that the delivery failure is caused by event (i) and/or event (ii) in a step S818. If event (i) occurs before event (ii), the SN stops performing HO command retransmissions, since the UE is now re-establishing to another cell. This saves air interface resources and processing resources at the SN.

Then, the SN generates an SN message indicating that the UE fails to receive the HO command due to event (i) and/or event (ii) and sends the SN message to the source MN in a step S820. The step S820 may be performed, for example, via a new message sent over an Xn interface. The SN may also include, in the SN message, additional information that will aid the MN in taking corrective actions (e.g., the elapsed value of the recovery timer when event (ii) occurs, and/or the number of performed retransmissions when event (i) occurs).

In response to the SN message, the source MN decides, in a step S822, to properly adjust the recovery timer such that similar delivery failures are minimized in the future.

It should be noted that each step or operation of the methods 300, 500, and 700, and the interaction diagram 800, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by the processors 202, 402, and 602, respectively. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the example embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1.-17. (canceled)

18. A Secondary Node (SN) in a wireless communication network, comprising:
a processor; and
a non-transitory computer-readable medium comprising computer-executable instructions that, when executed by the processor, cause the processor to perform the following operations:
receive, from a User Equipment (UE), a UE message indicating that a Radio Link Failure (RLF) occurs at the UE for a Master Cell Group (MCG) of a Master Node (MN) in the wireless communication network, the RLF for the MCG causing the UE to start a recovery timer upon transmitting the UE message from the UE to the SN;
based on a time instant at which the UE message is received by the SN, calculate a start time of the recovery timer at the UE;
transmit the UE message to the MN;
receive, from the MN, a MN message comprising a handover (HO) command for the UE, the HO command causing the UE to perform HO from the MN to a target MN, wherein the recovery timer comprises a timer duration indicated in the UE message or the MN message;
based on the start time and the timer duration, estimate when the recovery timer expires at the UE;
determine that the UE fails to receive the HO command due to the following events: (i) a number of retransmissions performed by the SN to deliver the HO command to the UE reaches a threshold before the recovery timer has expired, and (ii) the recovery timer expiring;
transmit, to the MN and a central entity in the wireless communications network, a SN message indicating that the UE fails to receive the HO command due to events (i) and (ii); and
based on the SN message indicating that the UE fails to receive the HO command due to events (i) and (ii), decrease the timer duration for future HO commands.

19. The SN of claim 18, wherein the SN message further indicates the following:
an elapsed value of the recovery timer when event (ii) occurs; and
the number of the retransmissions performed by the SN to deliver the HO command to the UE when event (i) occurs.

20. The SN of claim 19, wherein the MN delivers timer setting parameters to the UE earlier than the RLF.

21. The SN of claim 20, wherein each of the UE message, HO command, and the SN message are implemented as a corresponding radio resource control message.

22. The SN of claim 21, wherein the UE is an electronic computing device that is configured to perform wireless communications.

23. The SN of claim 22, wherein decreasing the timer duration for future HO commands is based at least in part on the UE not having an ability to receive the HO command until the timer duration expires.

24. The SN of claim 23, wherein the computer-executable instructions further cause the processor to, based on receiving the UE message indicating that the RLF occurred at the UE for the MCG of the MN in the wireless communication network, suspending MCG transmission of all bearers and not suspending Secondary Cell Group (SCG) transmissions.

25. A system comprising:
a wireless communication network;
a user equipment (UE);
a master node (MN) comprising a master cell group (MCG); and
a secondary node (SN) comprising:
a processor; and
a non-transitory computer-readable medium comprising computer-executable instructions that, when executed by the processor, cause the processor to perform the following operations:
receive, from the UE, a UE message indicating that a Radio Link Failure (RLF) occurs at the UE for the MCG of the MN in the wireless communication network, the RLF for the MCG causing the UE to start a recovery timer upon transmitting the UE message from the UE to the SN;
based on a time instant at which the UE message is received by the SN, calculate a start time of the recovery timer at the UE;
transmit the UE message to the MN;
receive, from the MN, a MN message comprising a handover (HO) command for the UE, the HO command causing the UE to perform HO from the MN to a target MN, wherein the recovery timer comprises a timer duration indicated in the UE message or the MN message;
based on the start time and the timer duration, estimate when the recovery timer expires at the UE;
determine that the UE fails to receive the HO command due to the following events: (i) a number of retransmissions performed by the SN to deliver the HO command to the UE reaches a threshold before the recovery timer has expired, and (ii) the recovery timer expiring;
transmit, to the MN and a central entity in the wireless communications network, a SN message indicating that the UE fails to receive the HO command due to events (i) and (ii); and
based on the SN message indicating that the UE fails to receive the HO command due to events (i) and (ii), decrease the timer duration for future HO commands.

26. The system of claim 25, wherein the SN message further indicates the following:
an elapsed value of the recovery timer when event (ii) occurs; and
the number of the retransmissions performed by the SN to deliver the HO command to the UE when event (i) occurs.

27. The system of claim 26, wherein the MN delivers timer setting parameters to the UE earlier than the RLF.

28. The system of claim 27, wherein each of the UE message, HO command, and the SN message are implemented as a corresponding radio resource control message.

29. The system of claim 28, wherein the UE is an electronic computing device that is configured to perform wireless communications.

30. The system of claim 29, wherein decreasing the timer duration for future HO commands is based at least in part on the UE not having an ability to receive the HO command until the timer duration expires.

31. The system of claim 30, wherein the computer-executable instructions further cause the processor to, based on receiving the UE message indicating that the RLF occurred at the UE for the MCG of the MN in the wireless communication network, suspending MCG transmission of all bearers and not suspending Secondary Cell Group (SCG) transmissions.

32. A method comprising:
receiving, by a secondary node (SN) from a User Equipment (UE), a UE message indicating that a Radio Link Failure (RLF) occurs at the UE for a Master Cell Group (MCG) of a Master Node (MN) in a wireless communication network, the RLF for the MCG causing the UE to start a recovery timer upon transmitting the UE message from the UE to the SN;
based on a time instant at which the UE message is received by the SN, calculating, by the SN, a start time of the recovery timer at the UE;
transmitting, by the SN, the UE message to the MN;
receiving, by the SN from the MN, a MN message comprising a handover (HO) command for the UE, the HO command causing the UE to perform HO from the MN to a target MN, wherein the recovery timer comprises a timer duration indicated in the UE message or the MN message;
based on the start time and the timer duration, estimating, by the SN, when the recovery timer expires at the UE;
determining, by the SN, that the UE fails to receive the HO command due to the following events: (i) a number of retransmissions performed by the SN to deliver the HO command to the UE reaches a threshold before the recovery timer has expired, and (ii) the recovery timer expiring;
transmitting, by the SN to the MN and a central entity in the wireless communications network, a SN message indicating that the UE fails to receive the HO command due to events (i) and (ii); and
based on the SN message indicating that the UE fails to receive the HO command due to events (i) and (ii), causing, by the SN, the timer duration for future HO commands to decrease.

33. The method of claim 32, wherein the SN message further indicates the following:
an elapsed value of the recovery timer when event (ii) occurs; and
the number of the retransmissions performed by the SN to deliver the HO command to the UE when event (i) occurs.

34. The method of claim 33, wherein the MN delivers timer setting parameters to the UE earlier than the RLF.

35. The method of claim 34, wherein each of the UE message, HO command, and the SN message are implemented as a corresponding radio resource control message.

36. The method of claim 35, wherein the UE is an electronic computing device that is configured to perform wireless communications.

37. The method of claim 36, wherein decreasing the timer duration for future HO commands is based at least in part on the UE not having an ability to receive the HO command until the timer duration expires; and wherein the computer-executable instructions further cause the processor to, based on receiving the UE message indicating that the RLF occurred at the UE for the MCG of the MN in the wireless communication network, suspending MCG transmission of all bearers and not suspending Secondary Cell Group (SCG) transmissions.
